(19) United States
(12) Patent Application Publication
(10) Pub. No.: US 2012/0027387 A1
(43) Pub. Date: Feb. 2, 2012

(54) VIDEO CONTROLLER AND VIDEO CONTROLLING METHOD

(75) Inventor: Yasuhiro MORIOKA, Kanagawa (JP)

(73) Assignee: Kabushiki Kaisha Toshiba, Tokyo (JP)

(21) Appl. No.: 13/088,170

(22) Filed: Apr. 15, 2011

(30) Foreign Application Priority Data
Jul. 28, 2010 (JP) 2010-169642

(51) Int. Cl. H04N 5/783

(52) U.S. Cl. 386/343; 386/E05.003

(57) ABSTRACT

A video controlling method is for a controller to perform when the controller receives a user instruction that designates a reproduction start position of a video content for reproducing the video content stored in a server device by a display device. The method includes: performing, when the position of the video content at the start time of the reproduction is ahead of the designated position, instructing the display device so that the reproduction of the video content pauses, and instructing the display device to perform reproduction after the instruction designating the reproduction start position is issued to the display device.

### CROSS-REFERENCE TO THE RELATED APPLICATION(S)

The present application is based upon and claims priority from prior Japanese Patent Application No. 2010-169642, filed on Jul. 28, 2010, the entire contents of which are incorporated herein by reference.

### FIELD

Embodiments described herein relate generally to a video controller and a video controlling method for controlling content reproduction in a display device.

### BACKGROUND

A display device that receives instructions from a video controller via a network and performs content reproduction has been defined on the basis of the UPnP AV (R) specifications. In the DLNA (R) (Digital Living Network Alliance) specifications based on the UPnP AV specifications, the display device is referred to as a digital media renderer (DMR), and the video controller is referred to as a digital media controller (DMC). Although similar apparatuses and operations can be determined according to specifications other than the UPnP AV and DLNA specifications, the functions and operations obtained according thereto are not much different from those according to the UPnP AV and DLNA specifications. In this kind of display device, it is assumed that there are two use cases, one use case in which the reproduction of the continuation of a content having been reproduced up to the middle is resumed later and the other use case in which the continuation of the content is reproduced using another display device. For the purpose of attaining the reproduction in these use cases, it is required that the display device can reproduce the content from a designated position, and the video controller attains the reproduction in the use cases by issuing a series of instructions.

According to the UPnP AV specifications and the DLNA specifications, the AVT:GetCurrentTransportActions action of AVTransport service is instructed from the video controller (DMC) to the display device (DMR). By virtue of the response therefrom, the video controller can grasp an instruction that can be received in the operational status of the display device at the time.

A relationship indicating which action (instruction) can be received in which state is implementation-dependent, and an action to the relationship and receivable in that state can be returned using the GetCurrentTransportActions action. However, the implementation of this action is optional and not a versatile process.

There is a demand for a video controller that causes a display device to reproduce a content from a designated position by using a more versatile process. However, means for satisfying this demand is not yet known.

### BRIEF DESCRIPTION OF THE DRAWINGS

A general configuration that implements the various features of the present invention will be described with reference to the drawings. The drawings and the associated descriptions are provided to illustrate embodiments of the invention and not to limit the scope of the invention.

FIG. 1 is a view showing a system configuration of a video controller and a display device according to an embodiment.

FIG. 2 is a transition diagram showing operational statuses of the display device according to the embodiment.

FIG. 3 is a perspective view showing an external appearance 1.5 of a computer according to the embodiment.

FIG. 4 is a block diagram showing a system configuration of the computer shown in FIG. 4.

FIG. 5 is a block configuration diagram showing the video controller according to the embodiment.

FIG. 6 is a flowchart showing a method in which the start position of a content in the video controller according to the embodiment is designated and reproduction is performed.

FIG. 7 is a sequence diagram showing content reproduction performed under the control of the video controller according to the embodiment after the start position is designated.

### DETAILED DESCRIPTION

According to the embodiments described herein, there is provided a video controlling method for a controller to perform when the controller receives a user instruction that designates a reproduction start position of a video content for reproducing the video content stored in a server device by a display device. The method includes: (1) instructing the display device to stop reproduction; (2) issuing, after performing step (1), an instruction designating the video content to be reproduced to the display device; (3) issuing, after performing step (2), an instruction designating the reproduction start position of the video content to the display device; (4) instructing, after performing step (3), the display device to reproduce said video content from the reproduction start position; (5) monitoring, after performing step (4), the reproduction state and the reproduction position of the video content; and performing either one of (6) or (7), when the position of the video content at the start time of the reproduction is ahead of the designated position after performing step (5), wherein in step (6), instructing the display device so that the reproduction of the video content pauses, and instructing the display device to perform reproduction after the instruction designating the reproduction start position is issued to the display device, and wherein in step (7), issuing an instruction designating said reproduction start position to said display device.

Embodiments according to the present invention will be described in detail with reference to the accompanying drawings. The scope of the claimed invention should not be limited to the examples illustrated in the drawings and those described in below.

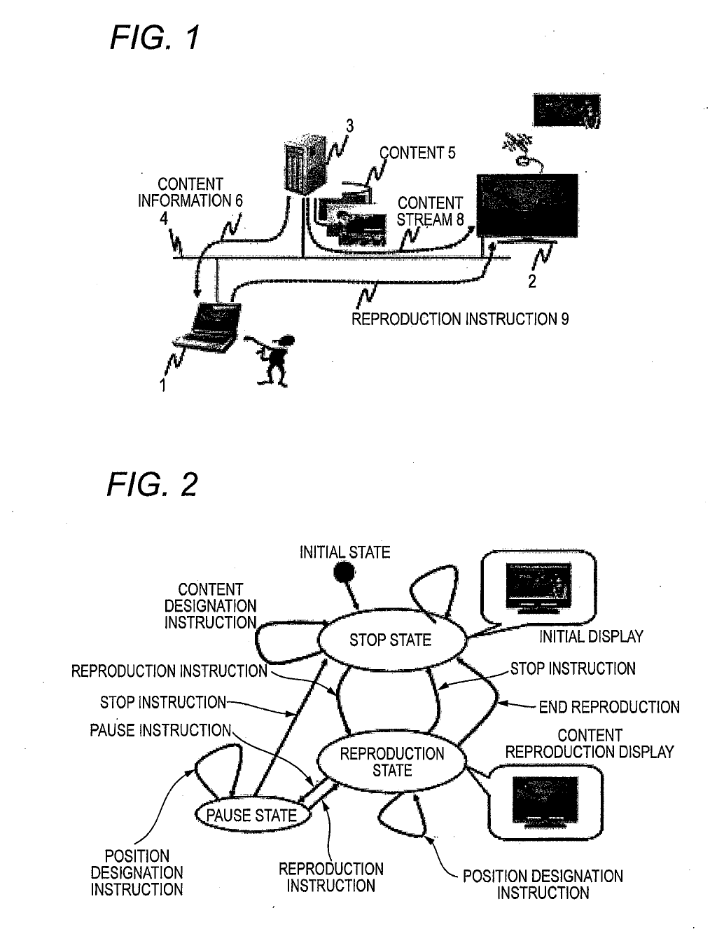

FIG. 1 is a view showing a system in which a video controller (digital media controller: DMC) according to an embodiment operates. A video controller 1 according to the embodiment is connected to a server device 3 and a display device (digital media renderer: DMR) 2 via a network 4, which is installed in a home. The user operates the video controller 1, selects a content 5 stored in the server device as an object to be reproduced and designates the display device 2 as a reproduction destination. The display device 2 obtains the content stream 8 of the content 5 from the server device 3 and reproduces and displays the content stream 8. In a process of reproducing a series of content 5 using the display device 2, the video controller 1 sometimes designates the reproduction start position of the content 5 in the display device 2. In this case, the display device 2 is requested to operate as if it is assumed, to the user, that the display device has started reproduction from the designated position (described later).

FIG. 2 is a view showing the operational statuses of the display device and examples of operation instructions issued from the video controller to cause transition in the operational status. The operational statuses consist of a stop state, a reproduction state and a pause state. Some types of display devices do not have the pause state. At the stop state, the display device receives a content designation instruction, and the operational status transits to the stop state (in this case, the operational status remains unchanged). In the stop state, the display device receives a reproduction instruction and tries to perform reproduction. If this is succeeded, the operational status transits to the reproduction state. In the reproduction state, if a stop instruction is received or the reproduction is ended, the operational status transits to the stop state. In the reproduction state, upon receiving a pause instruction, the display device temporarily stops reproduction, and the operational status transits to the pause state. In the pause state, when the display device receives the stop instruction, the operational status transits to the stop state. In the pause state, upon receiving the reproduction instruction, the display device restarts reproduction from the temporal stop position, and the operational status transits to the reproduction state. The reproduction start position in each state can be changed by a position designation instruction, that is, a seek instruction. At this time, the operational status remains unchanged in most types of display devices. The operational status capable of receiving the position designation instruction may be different depending on the type of the display device. FIG. 2 shows an example of transition in the state of the display device, but not showing all examples.

In the case that the display device reproduces a content from a designated position, the operation of the apparatus has a plurality of kinds of differences. Operational statuses significantly different and being capable of receiving a reproduction start position instruction are broadly classified into three types. Type 1: capable of receiving the instruction only in the reproduction state. Type 2: capable of receiving the instruction in the reproduction state and the pause state. Type 3: capable of receiving the instruction in the reproduction state, the pause state and the stop state. Furthermore, apparatuses allowed to be used as display devices are classified into two types. Type A: an apparatus wherein the start position designated at the stop position is reflected when the operational status transits to the reproduction state. Type B: an apparatus wherein the start position designated at the stop position is lost when the operational status transits to the reproduction state and reproduction is restarted from the head position of the content at all times. In UPnP AV and DLNA, these classifications are instructed from the video controller (DMC) to the display device (DMR) using the AVT:GetCurrentTransportActions action of the AVTransport service. In response to the action, the video controller can grasp an instruction that can be received in the operational status of the display device at the time.

However, the problem is that the AVT:GetCurrentTransportActions action is optional and not provided in all the display devices. Moreover, the difference between Type A and Type B can be determined only after the apparatuses are operated.

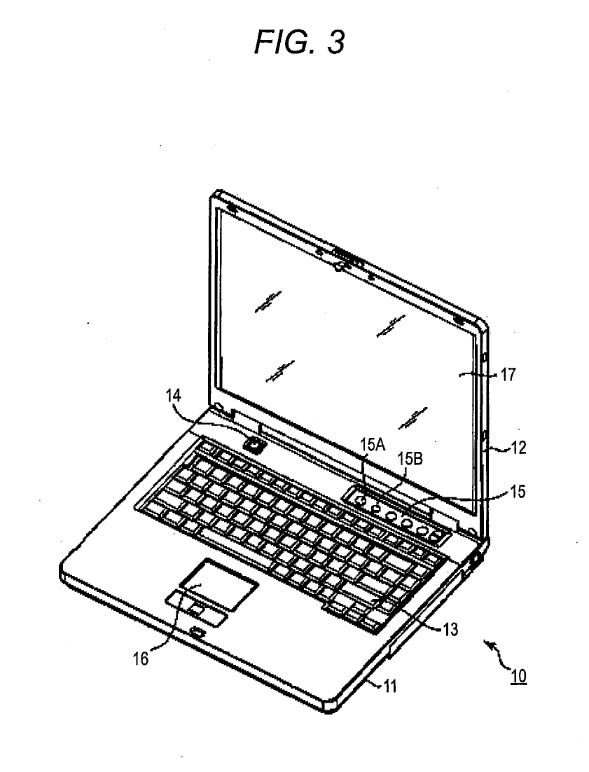

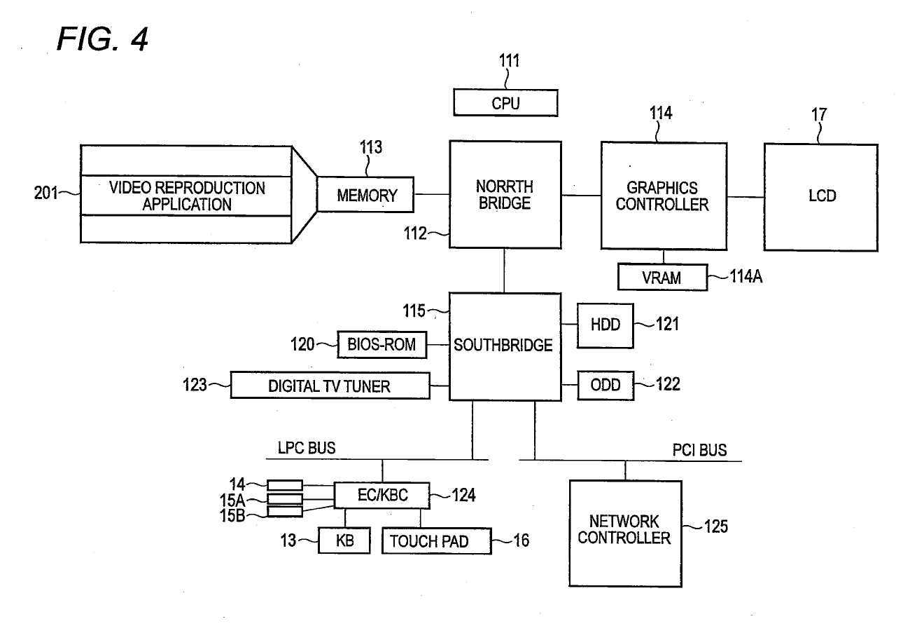

Next, the configuration of an information-processing apparatus according to an embodiment of the video controller 1 will be described below referring to FIGS. 3 and 4. This information-processing apparatus is embodied as a notebook personal computer 10, for example.

FIG. 3 is a front view showing a state in which the display unit of the notebook personal computer 10 is opened. The computer 10 is composed of a computer body 11 and a display unit 12. A display device formed of an LCD (liquid crystal display) 17 is built in the display unit 12, and the display screen of the LCD 17 is positioned near the center of the display unit 12.

The display unit 12 is installed so as to be pivotable with respect to the computer body 11 between an open position and a closed position. The computer body 11 has a low-profile box-shaped housing, and a keyboard 13, a power button 14 for turning on/off the power supply of the computer 10, an input operation panel 15, a touch pad 16, etc. are disposed on the upper face of thereof.

The input operation panel 15 is an input device for inputting an event corresponding to a button pressed and is equipped with a plurality of buttons for starting a plurality of functions. The group of these buttons includes a TV start button 15A and a DVD (digital versatile disc) start button 15B. The TV start button 15A is a button for starting a TV function for reproducing and recording broadcast program data, such as digital TV broadcast programs. When the TV start button 15A is pressed by the user, an application program for carrying out the to TV function is started automatically. The DVD start button 15B is a button for reproducing video contents recorded on a DVD. When the DVD start button 15B is pressed by the user, an application program for reproducing the video contents is started automatically.

Next, the system configuration of the computer 10 will be described below referring to FIG. 4.

As shown in FIG. 4, the computer 10 is equipped with a CPU 111, a northbridge 112, a main memory 113, a graphics controller 114, a southbridge 119, a BIOS-ROM 120, a hard disk drive (HDD) 121, an optical disc drive (ODD) 122, a digital TV tuner 123, an embedded controller/keyboard controller IC (EC/KBC) 124, and a network controller 125.

The CPU 111 is a processor provided to control the operation of the computer 10 and executes an operating system (OS) and various kinds of application programs, such as a video reproduction program 201, loaded from the hard disk drive (HDD) 121 to the main memory 113.

The CPU 111 has a cache memory, not shown, and part of various kinds of programs being executed and data related thereto are present in the cache memory and are used continuously without referring to the main memory once again and without minutely rewriting changed contents, whereby the efficiency of the processing can be improved.

In addition, the CPU 111 also executes the system BIOS (basic input output system) stored in the BIOS-ROM 120. The system BIOS is a program for controlling hardware.

The northbridge 112 is a bridge device for connecting the local bus of the CPU 111 to the southbridge 119. A memory controller for access-controlling the main memory 113 is also built in the northbridge 112. Furthermore, the northbridge 112 has a function for performing communication with the graphics controller 114 via an AGP (accelerated graphics port) bus or the like.

The graphics controller 114 is a display controller for controlling the LCD 17 that is used as the display monitor of the computer 10. This graphics controller 114 generates, from the image data written in a video memory (VRAM) 114A, a display signal to be transmitted to the LCD 17.

The southbridge 119 controls various devices on an LPC (low pin count) bus and various devices on a PCI (peripheral component interconnect) bus. Furthermore, the southbridge 119 incorporates an IDE (integrated drive electronics) controller for controlling the HDD 121 and the ODD 122. Moreover, the southbridge 119 also has a function for controlling the digital TV tuner 123 and a function for access-controlling the BIOS-ROM 120.

The HDD 121 is a storage unit for storing various kinds of software and data. The optical disc drive (ODD) 123 is a drive unit for driving storage media, such as a DVD, in which video contents are stored. The digital TV tuner 123 is a receiver for receiving broadcast program data, such as digital TV broadcast programs, from the outside.

The embedded controller/keyboard controller IC (EC/KBC) 124 is a single-chip microcomputer in which an embedded controller for power management and a keyboard controller for controlling the keyboard (KB) 13 and the touch pad 16 are integrated. The embedded controller/keyboard controller IC (EC/KBC) 124 has a function for turning on/off the computer 10 depending on the operation of the power button 14 by the user. In addition, the embedded controller/keyboard controller IC (EC/KBC) 124 can turn on the computer 10 depending on the operation of the TV start button 15A and the DVD start button B by the user. The network controller 125 is a communication device for performing communication to an external network, such as the Internet.

According to the embodiment, there is provided a video controller (digital media controller: DMC) capable of issuing a reproduction instruction by designating a robust reproduction start position for various implementations of the display device (digital media renderer: DMR).

The configuration of a conventional video controller and a reproduction procedure wherein a start position is designated will be described herein for comparison.

The conventional video controller is equipped with a reproduction request receiving module, a stop instruction module, a content designation instruction module, a start position designation instruction module, a reproduction instruction module, a state monitoring module, a seek reproduction determination module, a seek reproduction instruction module, and a pause instruction module.

For example, the following is a procedure for the conventional video controller on the assumption that the above-mentioned Type 1 and Type B of display devices are used.

Step A0: the video controller receives a reproduction instruction together with a content and the start position thereof from the user.

Step A1: the control apparatus finds a target display device.

Step A2: the control apparatus finds a target content. The content is set to a state of being accessible by another server device or the like on a network.

Step A3: the control apparatus instructs the display device to perform stop operation.

Step A4: the control apparatus issues an instruction designating the target content to the display device.

Step A5: the control apparatus instructs the display device to perform reproduction operation.

Step A6: the control apparatus obtains the operational status and the reproduction position of the display device.

Step A7: the control apparatus repeats the above-mentioned steps if the operational status is not the reproduction state.

Step A8: the control apparatus designates the reproduction start position.

A problem encountered in the conventional video controller is that the video and audio components of a content not included in a desired zone are eventually reproduced in the period from the time immediately after the start of reproduction to the time until the completion of seeking.

Furthermore, for example, the following is a procedure for the conventional video controller on the assumption that the above-mentioned “Type 3 and Type A” of display devices are used. In this case, the video controller is equipped with a reproduction request receiving module, a stop instruction module, a content designation instruction module, a start position designation instruction module, a reproduction instruction module, a state monitoring module, and a pause instruction module.

Step B0: the control apparatus receives a reproduction instruction together with a content and the start position thereof from the user.

Step B1: the control apparatus finds a target display device.

Step B2: the control apparatus finds a target content. The content is set to a state of being accessible by another server device or the like on the network.

Step B3: the control apparatus instructs the display device to perform stop operation.

Step B4: the control apparatus issues an instruction designating the target content to the display device.

Step B5: the control apparatus issues an instruction designating the reproduction start position to the display device.

Step B6: the control apparatus instructs the display device to perform reproduction operation.

A problem encountered in the conventional video controller is that it cannot be confirmed whether the reproduction start position designated in the stop state is reflected when the actual reproduction starts. Furthermore, there is no countermeasure to deal with this problem.

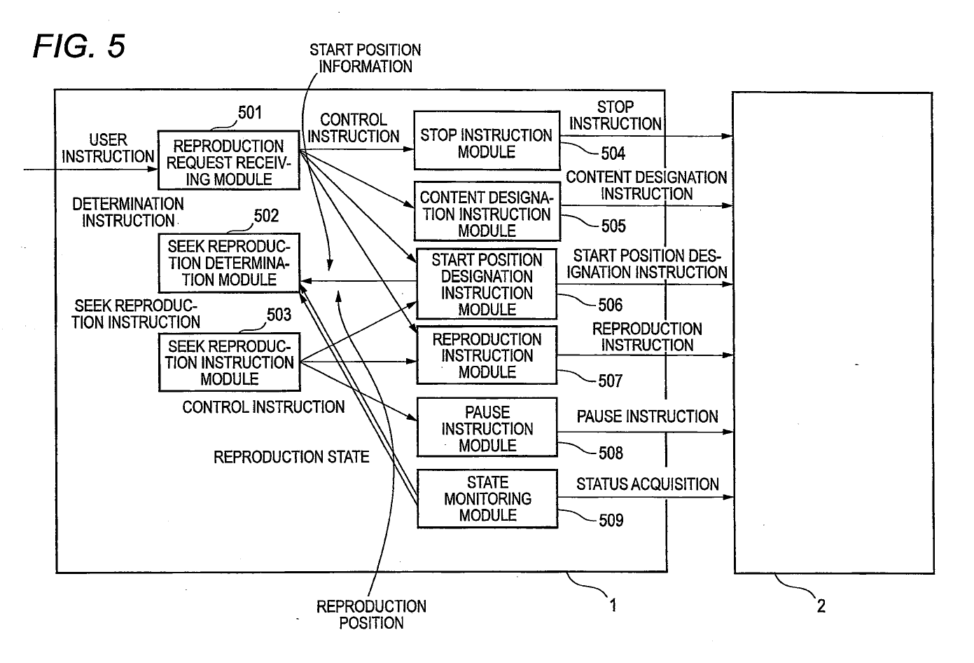

Next, FIG. 5 shows the configuration of functions mainly implemented by the video reproduction application program 201 of the video controller 1. The video controller 1 is equipped with a reproduction request receiving module 501, a stop instruction module 504, a content designation instruction module 505, a start position designation instruction module 506, a reproduction instruction module 507, a state monitoring module 509, a seek reproduction determination module 502, a seek reproduction instruction module 503, and a pause instruction module 508.

The reproduction function that is executed after a reproduction start position is designated by the user will be described below. First, the reproduction request receiving module 501 receives the operation of the user and distributes processing to the subsequent instruction modules.

The stop instruction module 504 stops the reproduction performed by the display device 2. The content designation instruction module 505 issues an instruction designating a target content to the display device 2. The start position designation instruction module 506 issues an instruction designating the reproduction start position of the content. The reproduction instruction module 507 instructs the reproduction of the content from the reproduction start position. The state monitoring module 509 monitors the reproduction state and the reproduction position. The seek reproduction determination module 502 determines whether the position at the start time of the reproduction is different from the designated position. The seek reproduction instruction module 503 pauses and performs seeking (to designate the reproduction start position) and sequentially issue reproduction instructions. The pause instruction module 508 issues a reproduction pause instruction.

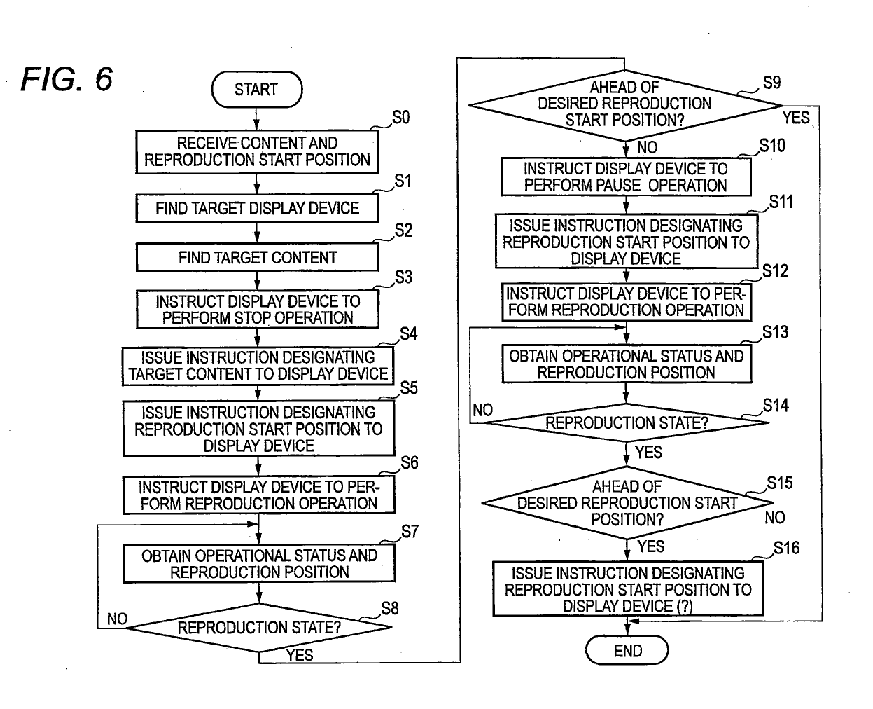

FIG. 6 is a flowchart showings reproduction procedure that is executed by the configuration shown in FIG. 5.

Step S0: the video controller receives a reproduction instruction together with a content and the reproduction start position thereof from the user.

Step S1: the control apparatus finds a target display device.

Step S2: the control apparatus finds a target content. The content is set to a state of being accessible by another server device or the like on a network.

Step S3: the control apparatus instructs the display device to perform stop operation.

Step S4: the control apparatus issues an instruction designating the target content to the display device.

Step S5: the control apparatus issues an instruction designating the reproduction start position to the display device.

Step S6: the control apparatus instructs the display device to perform reproduction operation.

Step S7: the control apparatus obtains the operational status and the reproduction position of the display device.

Step S8: if the operational status is not the reproduction state, the procedure returns to Step S7 described above. On the other hand, if the operational status is the reproduction state, the procedure advances to the next Step S9.

Step S9: if the reproduction position returned from the reproduction state and obtained at the above-mentioned Step S7 is not ahead of the desired reproduction start position at the above-mentioned Step S5, the control apparatus determines that the display device is in the desired reproduction state and ends the procedure. On the other hand, if the reproduction position is ahead of the reproduction start position, the procedure advances to the next Step S10.

Step S10: the control apparatus instructs the display device to perform pause operation.

Step S11: the control apparatus issues an instruction designating the reproduction start position to the display device.

Step S12: the control apparatus instructs the display device to perform reproduction operation.

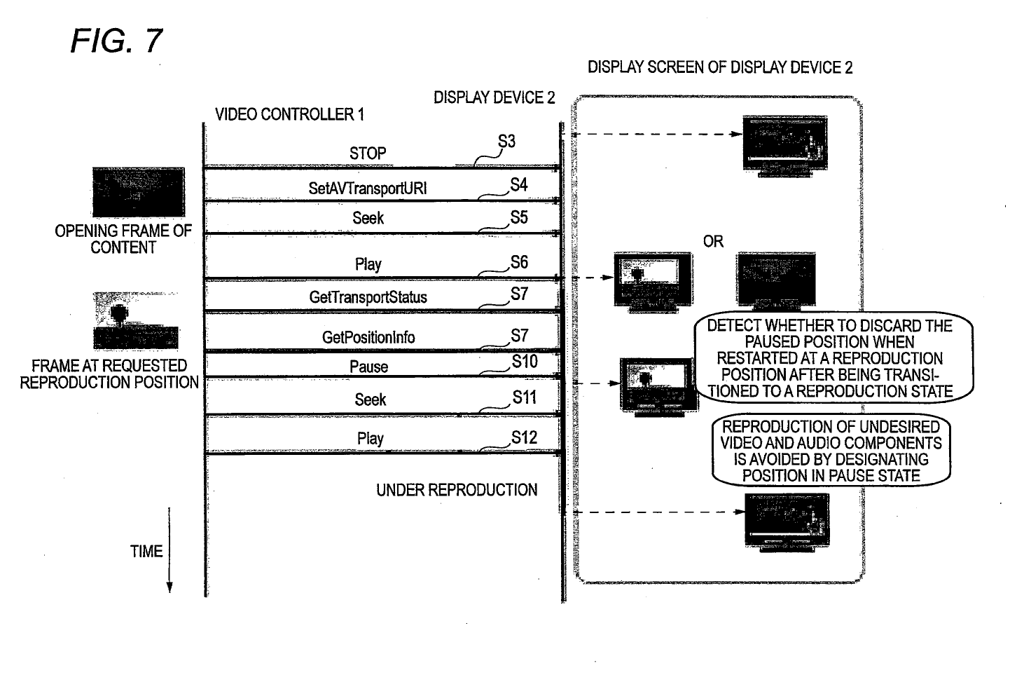

With these steps, as shown in a sequence diagram of FIG. 7, reproduction display can be performed from the predetermined reproduction position immediately after the start of reproduction, regardless of the implemented contents of the display device, or a situation in which undesired video and audio components are reproduced can be avoided by trying to designate the position in the pause state.

As a modified example of the embodiment, the following steps are added to the procedure up to the above-mentioned Step S12.

Step S13: the control apparatus obtains the operational status and the reproduction position of the display device.

Step S14: if the operational status is not the reproduction state, the procedure returns to the above-mentioned Step S13.

On the other hand, if the operational status is the reproduction state, the procedure advances the next Step S15.

Step S15: if the reproduction position returned from the reproduction state and obtained at the above-mentioned Step S13 is not ahead of the desired reproduction start position at the above-mentioned Step S5, the control apparatus determines that the display device is in the desired reproduction state and ends the procedure. On the other hand, if the reproduction position is ahead of the reproduction start position, the procedure advances to the next Step S16.

Step S16: the control apparatus issues an instruction designating the reproduction start position to the display device.

According to the modified example, the advantage expected to be obtained is also applicable to a display device in which seeking in the pause state is not processed properly. In other words, in any types (the above-mentioned Types 1, 2 and 3 and Types A and B) of display devices, reproduction display from the predetermined reproduction position can be performed using the display device while a situation in which undesired video and audio components are reproduced is avoided or the period of the situation is shortened.

In each type of display device, the following are specific steps at which the reproduction start position designation instruction issued by the video controller according to the present proposal becomes effective.

Type 1-A: Step S16

Type 1-B: Step S16

Type 2-A: Step S11, Step S12

Type 2-B: Step S11, Step S12

Type 3-A: Step S5

Type 3-B: Step S11, Step S12

In view of above, it may be summarized as below.

(1) The conventional typical video controller sets the start position after the operational status has become the reproduction state or sets the start position beforehand. Even in the latter case, there is no means or procedure for confirming whether reproduction is performed from the position.

(2) In the embodiment, the setting of the start position is first performed in the stop state. Immediately after the start of reproduction, a determination is made as to whether the setting of the start position in the stop state is effective. Depending on the result of the determination, a determination is made as to whether the setting of the start position is performed again after the start of reproduction. If the setting of the reproduction start position in the stop state is effective at the start time of the reproduction, it is possible to avoid a situation in which the content located ahead of the predetermined reproduction start position is output and displayed.

(3) When the setting of the start position after the start of reproduction is performed, the pause operation is executed and cancelled before and after the setting, whereby it can be expected that unintentional video and audio components are suppressed from being output until the change of the reproduction start position is reflected.

Since the video controller is equipped with the seek reproduction determination module and the seek reproduction instruction module as described above, the video controller compares the position at the time of the transition to the reproduction state with the reproduction start position obtained immediately after the transition. In the case that the reproduction position is not the predetermined reproduction position, a step for designating the reproduction start position again is included, whereby the video controller can deal with various kinds of operations of the display device.

The Points to be considered in solving problems encountered in the conventional art may be listed as below.

(1) The apparatus to be improved relates to a content video controller for controlling a content display device that receives instructions via a network and reproduces and displays contents transmitted from a network media server. The apparatus relates to a DMC (digital media controller) for a DMR (digital media renderer) in conformity with DLNA.

(2) The DMR has the stop state, reproduction state, transition state and pause state, and receives the stop instruction, reproduction instruction, reproduction start position instruction, pause instruction and reproduction content instruction.

(3) A case is assumed in which the reproduction of a certain content is restarted from the middle or the reproduction is passed to another DMR.

(4) A determination as to whether reproduction can be performed after the reproduction start position of a content is designated and the method for the determination are different depending on the type of the DMR. According to one method, the DMR receives the reproduction start position designation instruction in the stop state. After receiving the reproduction instruction, the DMR receives an instruction at the reproduction start position designated at which the reproduction instruction is received. According to another method, the DMR does not receive the reproduction start position designation instruction in the stop state but receives the reproduction start position designation instruction in the reproduction state or the pause state.

(5) The DMC is required to designate the reproduction start position and perform reproduction while paying attention to the fluctuation in the implementation of the DMR although it is unknown beforehand which one of the two methods described in item (4) is used (a method based on the return value of GetCurrentTransportActions is available but implemented optionally).

(6) Furthermore, it is desirable to avoid a situation in which video images are displayed before reproduction is started from a predetermined position.

Solution to problems will now be described.

A reproduction procedure, which consists of the following steps and is independent of the variation in the implementation of the DMR and in which the reproduction start position of a content is designated, is provided for the DMC.

Step (1): the DMC sets a reproduction stop state.

Step (2): the DMC designates a content to be reproduced.

Step (3): the DMC designates a reproduction start position.

Step (4): the DMC starts reproduction.

Step (5): the DMC executes Step (6) and the subsequent steps after the reproduction start state has reached.

Step (6): the DMC obtains the reproduction position.

Step (7): the DMC executes Step (7) and the subsequent steps if the current position is not the predetermined reproduction start position or the subsequent position.

Step (8): the DMC designates a pause.

Step (9): the DMC designates the reproduction start position.

Step (10): the DMC instructs reproduction (resumes reproduction).

In the embodiment, following points may be listed as advantages.

(1) Reproduction can be performed from the predetermined position according to the above-mentioned procedure, regardless of whether the DMR is subjected to seeking in the stop state and whether the start position in the stop state is reflected after the start of reproduction or abandoned.

(2) The problem that video images are displayed from undesired positions can be suppressed completely or substantially by trying to perform reproduction after the reproduction start position in the stop state has been designated and by designating the start position again in the case that the start position confirmed immediately after the start of reproduction is not the predetermined position.

Conventionally, either one of the two conventional methods is selected, or the methods are switched depending on the return value of optional GetCurrentTransportActions. The method according to the embodiment has the number of action calling times equivalent to those in the conventional methods and provides effects similar to those of the conventional methods, regardless of the provision of optional GetCurrentTransportActions.

The advantages of the method according to the embodiment are that reproduction from a designated position can be started by using the same procedure regardless of the behavior of the DMR and that the time required until reproduction is displayed from the predetermined position can be eliminated or shortened.

However, the video system may not be limited to the configuration according to the described embodiment, but can be modified variously within a range not departing from the gist of the invention. For example, Step S16 may be executed instead of Steps S10 to S12.

Although the embodiments according to the present invention have been described above, the present invention may not be limited to the above-mentioned embodiments but can be variously modified. Components disclosed in the aforementioned embodiments may be combined suitably to form various modifications. For example, some of all components disclosed in the embodiments may be removed or may be appropriately combined.

Additional advantages and modifications will readily occur to those skilled in the art. Therefore, the invention in its broader aspects may not be limited to the specific details and representative embodiments shown and described herein. Accordingly, various modifications may be made without departing from the spirit or scope of the general inventive concept as defined by the appended claims and their equivalents.

What is claimed is:

1. A video controlling method for a controller to perform when the controller receives a user instruction that designates a reproduction start position of a video content for reproducing the video content stored in a server device by a display device, the method comprising:
(1) instructing the display device to stop reproduction;
(2) issuing, after performing step (1), an instruction designating the video content to be reproduced to the display device;
(3) issuing, after performing step (2), an instruction designating the reproduction start position of the video content to the display device;
(4) instructing, after performing step (3), the display device to reproduce said video content from the reproduction start position;
(5) monitoring, after performing step (4), the reproduction state and the reproduction position of the video content; and
performing either one of (6) or (7), when the position of the video content at the start time of the reproduction is ahead of the designated position after performing step (5), wherein in step (6), instructing the display device so that the reproduction of the video content pauses, and instructing the display device to perform reproduction after the instruction designating the reproduction start position is issued to the display device, and wherein in step (7), issuing an instruction designating the reproduction start position to said display device.

2. The method of claim 1,
wherein each of steps (1) to (7) conform to the UPnP AV (Universal Plug and Play Audio Visual) specification.

3. The method of claim 1,
wherein each of steps (1) to (7) conform to the DLNA (Digital Living Network Alliance) specification.

4. The method of claim 1 further comprising:
issuing an instruction designating the reproduction start position to the display device when the position of the video content at the start time of the reproduction is ahead of the designated position when step (6) is performed.

5. A video controller comprising:
a reproduction request receiving module configured to receive a user instruction that designates a reproduction start position of a video content for reproducing the video content stored in a server device by a display device;
a stop instruction module configured to instruct the display device to stop reproduction when the user instruction is received;
a content designation instruction module configured to issue an instruction designating the video content to be reproduced to the display device after the stop instruction;
a start position designation instruction module configured to issue an instruction designating the reproduction start position of the video content to the display device after the instruction designating the video content;
a reproduction instruction module configured to instruct the display device to reproduce the video content after the instruction designating the reproduction start position;
a state monitoring module configured to monitor the reproduction state and the reproduction position of the video content after the instruction designating the reproduction start position;
a seek reproduction determination module configured to determine whether the position of the video content at the start time of the reproduction is different from the designated position after the monitoring;
a seek reproduction instruction module configured to issue pause, seek and reproduction instructions when the position of the video content at the start time of the reproduction is ahead of the designated position after the determination; and
a pause instruction module configured to instruct the production apparatus to cause reproduction to pause according to the pause instruction,
wherein the start position designation section issues an instruction designating the reproduction start position to the display device according to the seek instruction, and the reproduction instruction module instructs the display device to reproduce the video content from the reproduction start position according to the reproduction instruction.
